(19) United States
(12) Patent Application Publication
(10) Pub. No.: US 2025/0209299 A1
(43) Pub. Date: Jun. 26, 2025

(54) SYSTEM AND METHOD FOR NEURAL NETWORK BASED CONTINUOUS PROCESS SIMULATOR

(71) Applicant: Genpact USA, Inc., New York, NY (US)

(72) Inventors: Vivek Saxena, Gurgaon (IN); Vikram Jha, Sealdah (IN); Lavi Sharma, Gurgaon (IN); Harmeet Kaur, Gurgaon (IN)

(21) Appl. No.: 18/391,821

(22) Filed: Dec. 21, 2023

(51) Int. Cl. G06N 3/04; G06N 3/08; G06Q 10/1093

(52) U.S. Cl. CPC G06N 3/04; G06N 3/08; G06Q 10/1097

(57) ABSTRACT

A method for transforming a periodic event into a continuous one includes receiving data related to a periodic event for an organization where the data include activities corresponding to processes to be completed in the periodic event, generating a graph representing a calendar that includes one or more process, sub-process or task nodes, and inputting the graph and the data associated with the graph into a multi-layer neural network, to cause the multi-layer neural network to generate one or more simulated events. In a specific application, the simulated events include simulated close scenarios that drive a financial close towards a continuous close, where a simulated event includes various dimensions and attributes, where each driver/attribute choice or combination of choices has its own multitude of impacts, interdepend critical path and change management. The multi-layer neural network helps with modeling different simulations to arrive at an optimal basket of choices suited for a defined scenario.

### TECHNICAL FIELD

This disclosure generally relates to computer systems and methods for financial close automation technology, and more particularly to techniques for configuring continuous financial close based on neural network based close scenario simulations.

### BACKGROUND

Month-end close is an intrinsic function of every finance organization. Controllers are always curious to benchmark their month-end process to determine the effectiveness of their methods, the team's competence, and the likelihood of achieving an accelerated close. Development of financial closing and reporting tools in the past has been mainly focused on certain acceleration processes, including but not limited to automatic account reconciliation, pulling through missing transactions into journals, improving the flows of data through ERP® to speed up closing, automatically compiling reports after closing, cloud-based solution for improved scalability, etc.

However, the focus on financial close and reporting is now shifting from an accelerated or optimized close to a continuous close or continuous accounting. By continuous close, it means that on a given date if a business controller or CFO wants to look at their financials, they are enabled to have a look at their financials and report to the market, which will be enabled by the event-based and real-time accounting of the transactions. However, currently, there is no effective tool that can direct a financial close and reporting process to a continuous close.

Accordingly, there is a need for an improved financial close and reporting tool.

### SUMMARY

To address the aforementioned shortcomings, a method and system for transforming a periodic event are provided. The method includes receiving data related to a periodic event for an organization, the data including a number of activities corresponding to one or more processes to be completed in the periodic event, where each process includes one or more sub-process and each sub-process includes one or more tasks to be completed in the periodic event; generating a graph representing a calendar for completing each task included in the periodic event, where the graph includes one or more process nodes representing the one or more processes, one or more sub-process nodes representing the one or more sub-processes included in each process, and one or more task nodes representing the one or more tasks included in each sub-process; and inputting the graph and the data associated with the graph into a multi-layer neural network, to cause the multi-layer neural network to generate one or more simulated events, where the graph governs dataflow of the data through the multi-layer neural network, and where each of the one or more simulated events includes at least one task to be completed according to an alternative procedure that is different from an existing procedure for completing the at least one task, and where each of the one or more simulated events flattens the periodic event by reducing efforts to be placed during a predefined time range when completing each task included in the periodic event.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 is a block diagram of an example architecture for a continuous close acceleration application system, according to embodiments of the disclosure.

FIG. 2 illustrates example components included in a continuous close acceleration application, according to embodiments of the disclosure.

FIG. 3A illustrates an example architecture for a cross industry close simulator, according to embodiments of the disclosure.

FIG. 3B illustrates an example tree type graph representing a close calendar, according to embodiments of the disclosure.

FIG. 4 illustrates an example architecture for a close data ingestion layer, according to embodiments of the disclosure.

FIG. 5A illustrates an example architecture for a close analytics engine, according to embodiments of the disclosure.

FIG. 5B illustrates example close metrics for a current close, according to embodiments of the disclosure.

FIG. 6A illustrates an example architecture for a close scenario generation module, according to embodiments of the disclosure.

FIG. 6B illustrates an example implementation of a close scenario generation module, according to embodiments of the disclosure.

FIG. 7A illustrates an example architecture for an optimal close implementation engine, according to embodiments of the disclosure.

FIG. 7B illustrates an example peak comparison of a current close and three different simulated close scenarios, according to embodiments of the disclosure.

FIG. 7C illustrates an example transformation roadmap, according to embodiments of the disclosure.

FIG. 8 is a flow chart of an example method for generating a simulated close scenario, according to embodiments of the disclosure.

FIG. 9 is a block diagram of an example computer for a continuous close acceleration application system, according to embodiments of the disclosure.

### DETAILED DESCRIPTION

The figures (FIGS.) and the following description relate to some embodiments by way of illustration only. It is to be noted that from the following description, alternative embodiments of the structures and methods disclosed herein will be readily recognized as viable alternatives that may be employed without departing from the principles of the present disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Over the past few years, there has been a rapid increase in the number of organizations implementing financial close software for tracking and governance, making sure activities are completed within the defined timelines. For example, in order to transform their close process, leading companies have been implementing close automation software in the past few years. By leveraging an automated solution, organizations like leading companies have seen dramatic gains in both the efficiency and effectiveness of their financial close management. However, despite the growth in the adoption rate, automated solutions for the office of finance have faced challenges since information still remains periodic rather than continuous and in real-time the business demands today.

A technical solution provided in the present disclosure effectively improves the automated solutions for the office of finance by transforming a generally periodical financial close process to a continuous close (“close” may refer to accounting close and reporting and “continuous close” may refer to continuous close and reporting throughout the specification), which allows the visibility of financials in an organization to be available at any given day of a month/quarter/year. According to some embodiments, the technical solution disclosed herein includes a multi-layer neural network model that is developed to characterize current financial close data as a graph, which represents both the features of individual activity and the complicated relations between activities for the financial close data. The developed graph can be further input into a multi-layer neural network, which may be configured to analyze data associated with the current close and automatically generate a number of simulated close scenarios, including possible close scenarios that drive the financial close towards a continuous close. These simulated close scenarios include various dimensions and attributes, where each driver/attribute choice or combination of choices may have its own multitude of impacts, interdepend critical path, and change management. The multi-layer neural network helps in modeling different simulations to arrive at an optimal basket of choices (or solutions as will be described later) suited for a defined scenario.

The technical solution disclosed herein shows advantages when compared to other existing financial close software. First, the neural network based simulation of different close scenarios provides an effective approach to implementing a continuous close, which then enables a controller to look at financial reports at any given point in time. In addition, due to the complexity and volatility of the financial activities, the graph constructed on the financial data is often heterogeneous or time-varying, which imposes challenges on modeling technology. A neural network model disclosed herein can handle the complex graph structure and achieve great performance and thus could be used to solve financial tasks effectively. This then allows to accurately simulate various close scenarios even under the dynamic financial environment, thereby allowing a continuous close to be achieved through the disclosed approach.

It is to be noted that the benefits and advantages described herein are not all-inclusive, and many additional features and advantages will be further described under the context of specific embodiments. In addition, some additional features and advantages will become apparent to one of ordinary skill in the art in view of the figures and the following descriptions.

### Overall System

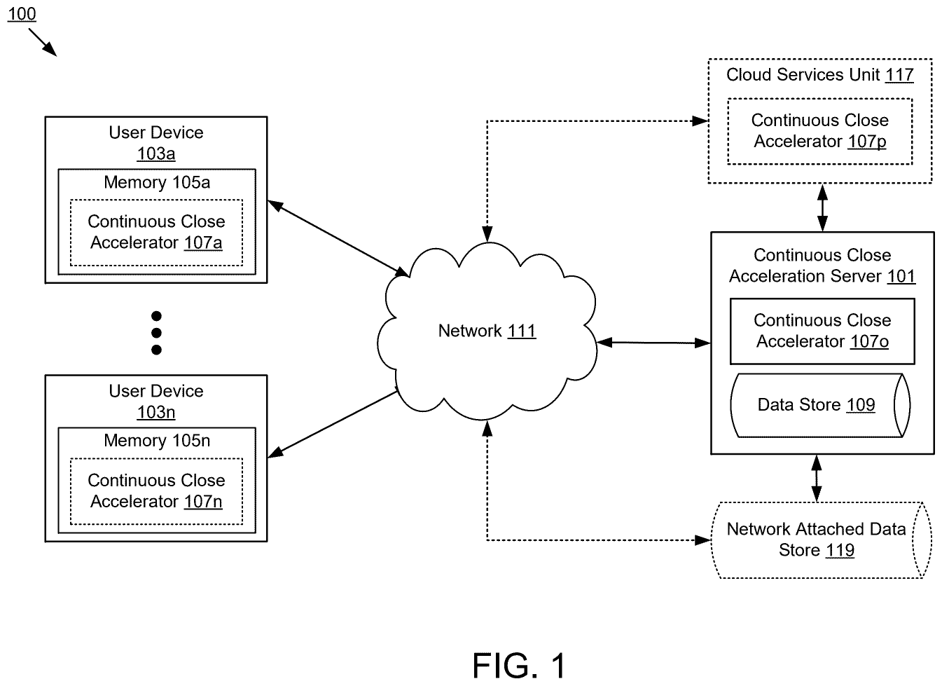

FIG. 1 is a block diagram of an example continuous close acceleration application system 100, according to embodiments of the disclosure. The continuous close acceleration application system 100 may be a network-based specialized computer environment (e.g., a cloud-based environment) for neural network-based simulation of various close scenarios for an organization and further defining a roadmap towards implementing a continuous financial close for the organization based on the simulated close scenarios.

As illustrated in FIG. 1, the continuous close acceleration application system 100 may include one or more user devices 103a . . . 103n, which can be specialized computers or other machines that are specifically configured to provide user inputs for master industry data upload and/or retrieval and for further specifying tasks, and/or provide guide or instructions related to close, among other possible applications. In one example, the user devices 103a . . . 103n (together or individually referred to as “user device 103”) may refer to multiple specialized computers associated with different organizations or different entities within an organization (e.g., different departments of a company). In one example, each user device 103 may be associated with a specific industry across a large number of different industries (e.g., retail, life science, manufacturing and hi-tech, services, banking, insurance, consumer packaged goods (CPG), etc.). In addition, in some embodiments, each specialized computer or user device may be configured to implement the same or different functions in a continuous close acceleration application. For example, each user device 103 may optionally include an instance of continuous close accelerator 107a or 107n stored in memory 105a or 105n, where each instance of continuous close accelerator may be configured to perform partial or full functions related to continuous close acceleration.

In some embodiments, a user device 103 may be a part of distributed computing topology, in which data collection and early stages of data processing are implemented close to the sites where tasks, events, or activities associated with the data occur. Distributed computing topology brings certain early stages of processing to the devices where it's being gathered, rather than relying all on a central location (e.g., continuous close acceleration server 101) that can be thousands of miles away. This is done so that data, especially real-time data, does not suffer latency issues that can affect a continuous close acceleration application's performance. In addition, the amount of data that needs to be sent to a centralized or cloud-based location is also reduced, which saves the bandwidths required by the disclosed continuous close acceleration application system 100.

As shown in FIG. 1, the continuous close acceleration application system 100 may additionally include a continuous close acceleration server 101. According to some embodiments, the continuous close acceleration server 101 may sit between user devices 103 and a data center (e.g., data store 109) or cloud (e.g., cloud services unit 117 and network attached data store 119) associated with an organization. By configuring a continuous close acceleration server 101 in the continuous close acceleration application system 100, it allows data orchestration and transformation across multiple entities (e.g., through different departments) within an organization. In addition, in some embodiments, the continuous close acceleration server 101 may be configured to have a higher computation power than the user devices 103, and thus some intensive data computations such as neural network based scenario simulation may be implemented on the server 101 instead, which saves the computation resources and/or reduces the requirement for computation power of each specific user device 103. In some embodiments, continuous close acceleration server 101 may be separately housed from other devices within the continuous close acceleration application system 100, such as user devices 103. Alternatively, a continuous close acceleration server 101 may be part of a device or system, e.g., may be integrated with a user device 103 to form an integrated user device of the continuous close acceleration application system 100.

In some embodiments, continuous close acceleration server 101 may host a variety of different types of data processing capacities as part of the continuous close acceleration application system 100, as will be described more in detail later. In addition, continuous close acceleration server 101 may also receive a variety of different data from user devices 103, from cloud services unit 117, or from other sources. The data may have been obtained or collected from one or more entities (e.g., through one or more user devices) or may have been received as inputs from an external system or device (e.g., through emails, mobile applications, web). In some embodiments, continuous close acceleration server 101 may be configured to perform other functions not described above. For example, continuous close acceleration server 101 may implement certain actions related to general financial close, such as account reconciliation and journal entries.

In some embodiments, continuous close acceleration server 101 may communicate with other components of the system 100 through a data communication interface(s). For example, user devices 103 may collect and send industry-specific close related data to the continuous close acceleration server 101 to be processed therein, and/or may send signals to the continuous close acceleration server 101 to control different aspects of the data it is processing (e.g., data to be included in an industry calendar), among other possibilities. User devices 103 may interact with the continuous close acceleration server 101 through several ways, for example, over one or more networks 111.

Networks 111 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 111 may include a short-range communication channel, such as Bluetooth or a Bluetooth low energy channel. A wired network may include a wired interface. The wired and/or wireless networks may be implemented using routers, access points, bridges, gateways, or the like, to connect devices in the system 100. The one or more networks 111 may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or task completion details may be encrypted.

In some embodiments, continuous close acceleration application system 100 may further include one or more network-attached datastores 119. Network-attached datastore 119 may be configured to store data managed by user devices 103 and/or the continuous close acceleration server 101 in a cloud environment. Network-attached datastore 119 may store a variety of different types of data organized in a variety of different ways and from a variety of different sources. For example, network-attached datastore 119 may store time series data, unstructured (e.g., raw) data, such as audio and video data and hand-written graphs, or structured data.

In some embodiments, the continuous close acceleration application system 100 may additionally include one or more cloud services units 117. A cloud services unit 117 may include a cloud infrastructure system that provides cloud services. In some embodiments, the computers, servers, and/or systems that make up the cloud services unit 117 are different from a user or an organization's own on-premises computers, servers, and/or systems.

In some embodiments, services provided by the cloud services unit 117 may include a host of services that are made available to users of the cloud infrastructure system on demand. For example, the services provided by the cloud services unit 117 may include, but are not limited to, machine learning model (e.g., neural network used for close simulation) development, training, and deployment (e.g., deployed to the continuous close acceleration server 101 or user device 103), messaging, social networking, data processing, image processing, audio-to-voice conversion, video-to-voice conversion, emailing services, intelligent analytics, Software as a service (SaaS), natural language processing, conversational artificial intelligence (AI), or any other services accessible to online users or user devices. In some embodiments, cloud services unit 117 may be utilized by the continuous close acceleration server 101 as a part of the extension of the server, e.g., through a direct connection to the server or through a network-mediated connection.

In some embodiments, services provided by the cloud services unit 117 may dynamically scale to meet the needs of its users. For example, cloud services unit 117 may house one or more continuous close acceleration accelerators 107p, which may be scaled up and down based on the number and complexity of close scenarios to be included in continuous close acceleration at any time point.

It should be also noted that, while various devices, server, and services unit are illustrated in the continuous close acceleration application system 100 in FIG. 1, it will be appreciated that more or fewer components may be used instead. For example, continuous close acceleration server 101 may include a server stack. As another example, cloud services unit 117 and/or network-attached datastore 119 may be not included in the continuous close acceleration application system 100. In addition, in some embodiments, the functions included in each instance of continuous close accelerator 107a/107n/107o/107p (together or individually referred to as “continuous close accelerator 107”) in different devices may be the same or different. In one example, different instances of continuous close accelerator 107 from different devices collaboratively complete one or more functions. For example, one or more user devices 103 and the continuous close acceleration server 101 may collaboratively serve as a hub for modeling financial close, simulating scenarios for alternative continuous close paths, and enabling continuous close in enterprises, where each instance of the application may perform a different layer of processes or functions. In the following, continuous close accelerator 107 included in the continuous close acceleration server 101, user devices 103, or cloud services unit 117 will be described further in detail with reference to specific modules, engines, or components, and their associated functions.

### Continuous Close Accelerator

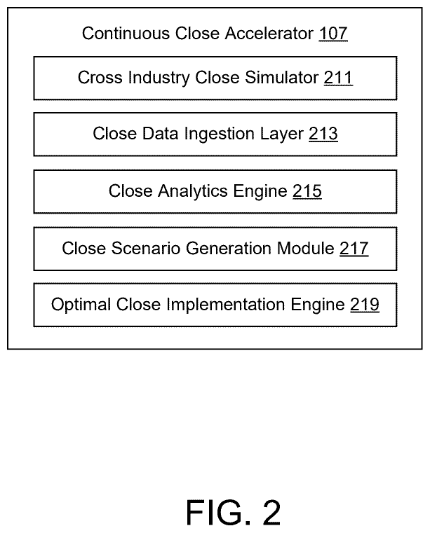

FIG. 2 illustrates example components included in a continuous close accelerator 107, according to some embodiments of the disclosure. As illustrated, the continuous close accelerator 107 may include a cross industry close simulator 211, a close data ingestion layer 213, a close analytics engine 215, a close scenario generation module 217, and an optimal close implementation engine 219.

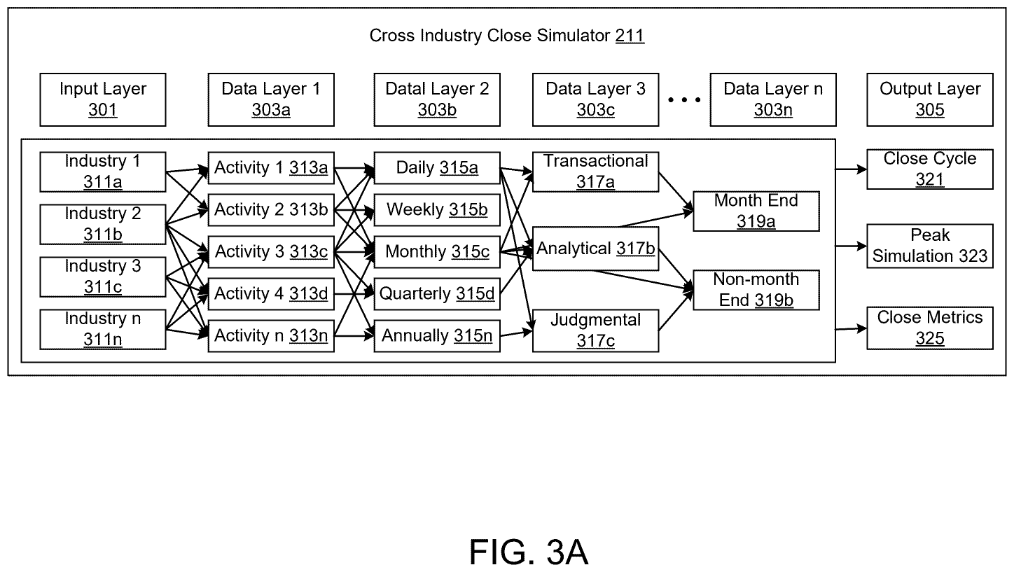

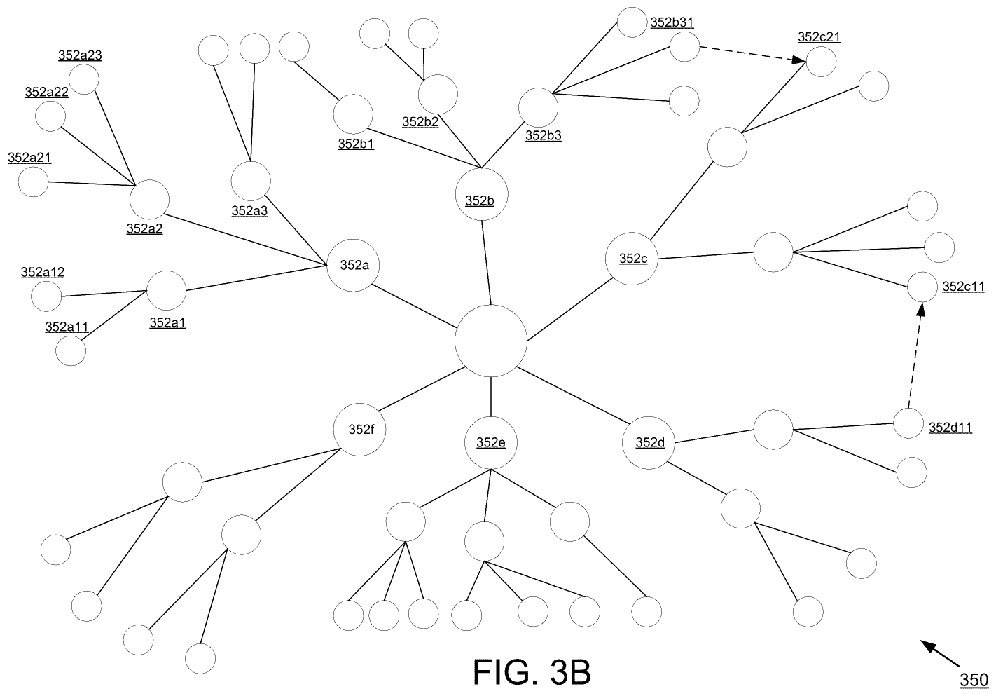

The cross industry close simulator 211 may be configured to generate or simulate one or more close calendars for a variety of different industries (e.g., retail, life science, manufacturing & Hi-Tech, services, banking, insurance, CPG, etc.). Each simulated industry-specific close calendar may include one or more processes required for a financial close for that industry. In some embodiments, each process may further include one or more sub-processes, where each sub-process may further include one or more specific tasks. In some embodiments, the generated close calendars may be presented as a tree type graph, where each of the processes, sub-processes, and tasks included therein may be represented by a node (which may be also referred to as dimension) in a tree. The linkages between these nodes in the tree may reflect the relationships between the nodes. In addition, each node may have predefined attributes associated with each node (e.g., attributes associated with each task). In some embodiments, the generated tree type graph may be fed into a multi-layer machine learning based neural network (which may be a graph neural network) for further data processing, such as aggregating of features associated with each node through one or more data layers included in the neural network, and/or generating one or more simulated close scenarios as will be described in detail later in FIGS. 3A-3B.

In some embodiments, the generated graph may be a dynamic graph that can be self-learning and continuously updated. For example, the nodes along with their attributes in the graph may evolve based on the aggregation of close activities across different industries. In some embodiments, the cross industry close simulator 211 may act as a library, for example, by generating a crop of industry-specific simulated close scenarios, which can be further fed into various analytics engines (e.g., close analytics engine 215), peak load simulator, and scenario generation module (e.g., close scenario generation module 217), etc.

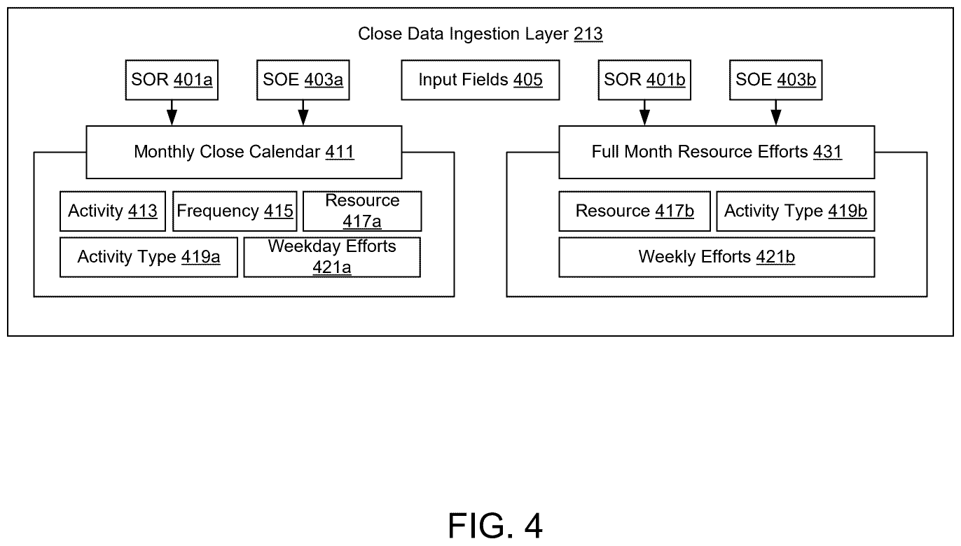

The close data ingestion layer 213 may act as the input gathering engine for a specific close evaluation, for example, by extracting data from the systems of record (SORs), systems of collaboration (SOCs), and/or systems of engagement (SOEs). The data may be extracted based on the specific industries. For example, data may be collected to fill in and/or update attributes associated with each node described above, which can vary industry by industry. In some embodiments, the close data ingestion layer 213 may further act in tandem with the cross industry close simulator 211 to flag deficiencies in data including missing data based on its machine learning models (e.g., based on the nodes included in the tree type graph). This then ensures that comprehensive and accurate data is fed into the close analytics engine 215. The specific functions of the close data ingestion layer 213 are further described in FIG. 4.

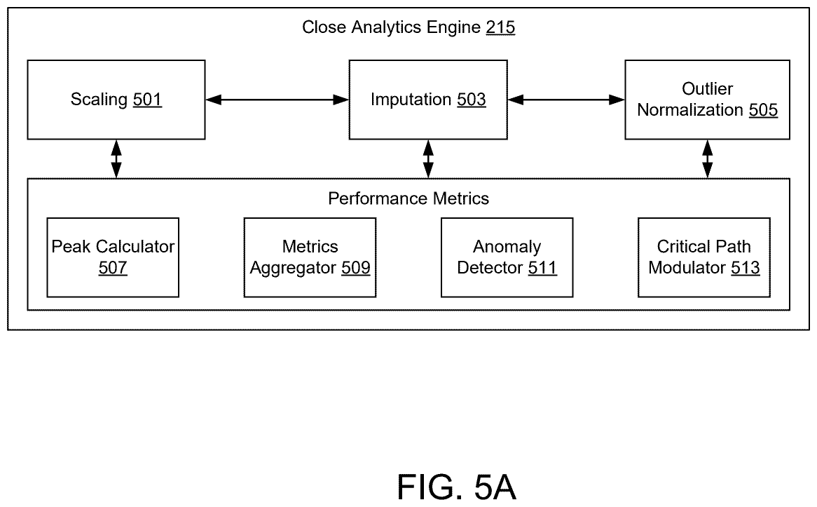

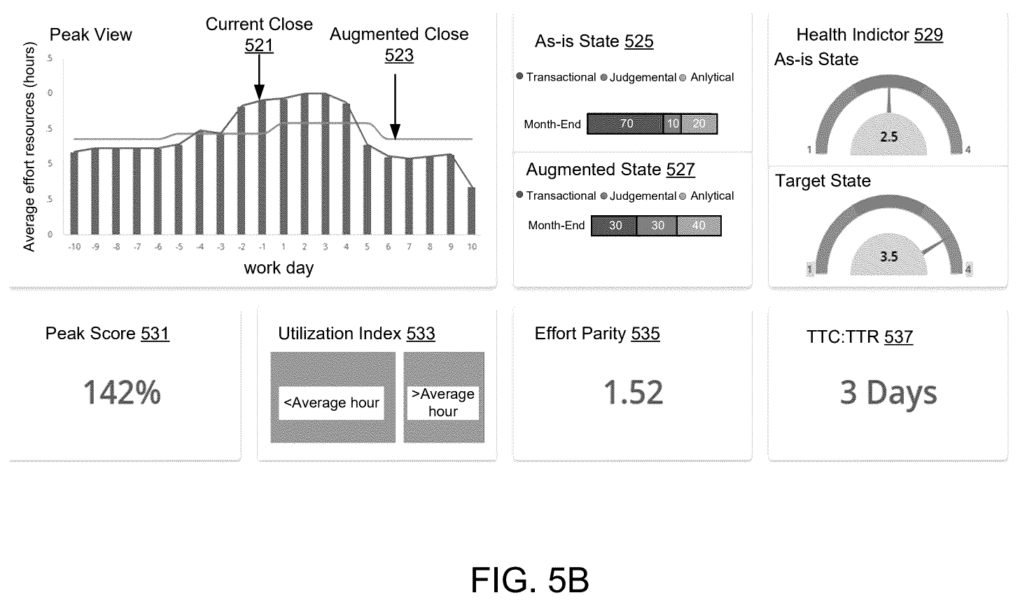

The close analytics engine 215 may be configured to perform various analyses for the data fed into the engine, including data for a current close cycle. For example, the close analytics engine 215 may compute the close metrics for the current close cycle, visualize the peak load of the cycle, provide a drill down of the peak load into various sub-processes and their drivers (e.g., identify the parent-child relationships) to map the critical path scenario analysis, and enable an analysis of each and every underlying activity. In some embodiments, through the analysis, one or more tasks may be identified as challenging tasks as these tasks may cause problems in transforming a current close to a continuous close. The specific functions of the close analytics engine 215 are further described in FIGS. 5A-5B.

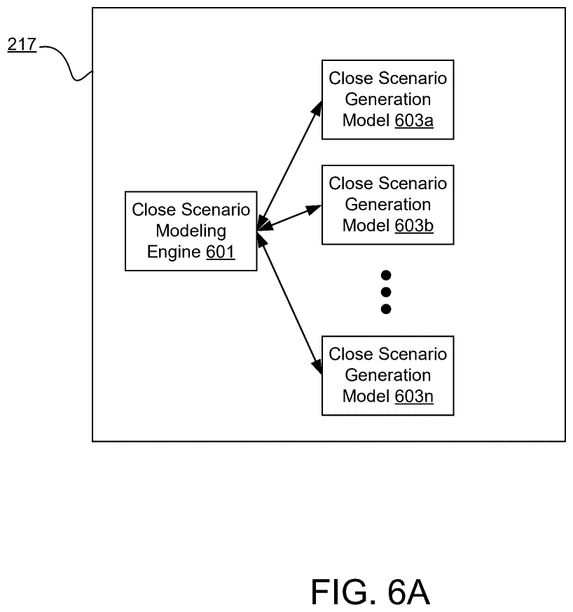

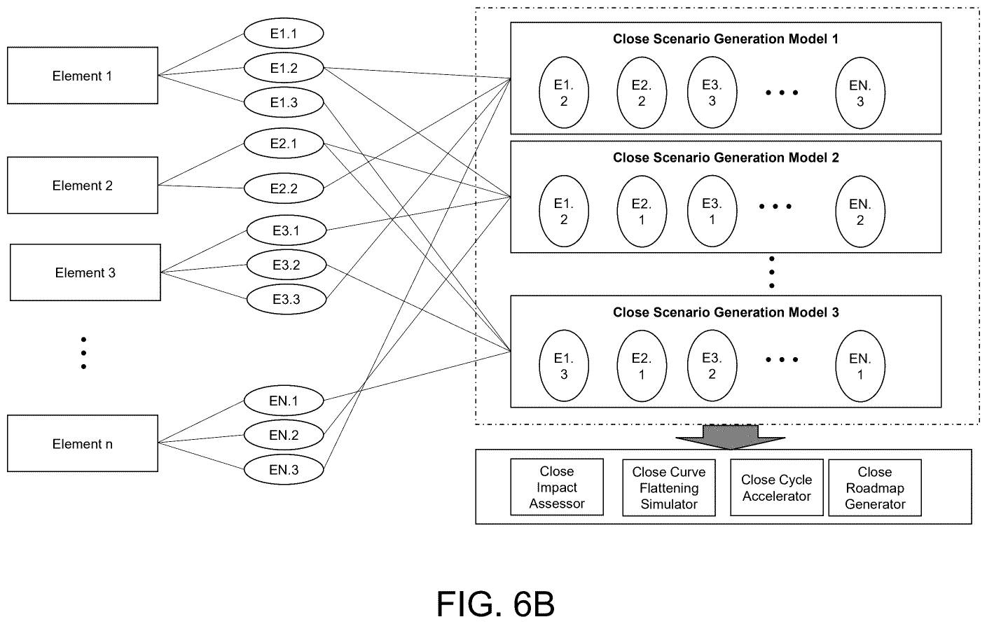

The close scenario generation module 217 may be configured to generate a series of simulated close scenarios. Briefly, the close scenario generation module 217 may identify one or more solutions for the challenging tasks identified by the close analytics engine 215. As part of the transformation initiatives, there are multiple solutions available, where each solution may lead to different outcomes in terms of their impact on peak load and/or close cycle reduction. The different solutions may be interlinked and the impact of one solution often causes a cascading effect on several other dependent activities. The close scenario generation model 217 may take into account the likely impacts input from the cross industry close simulator 211 when simulating alternative close scenarios. The specific functions of the close scenario generation module 217 are further described in FIGS. 6A-6B.

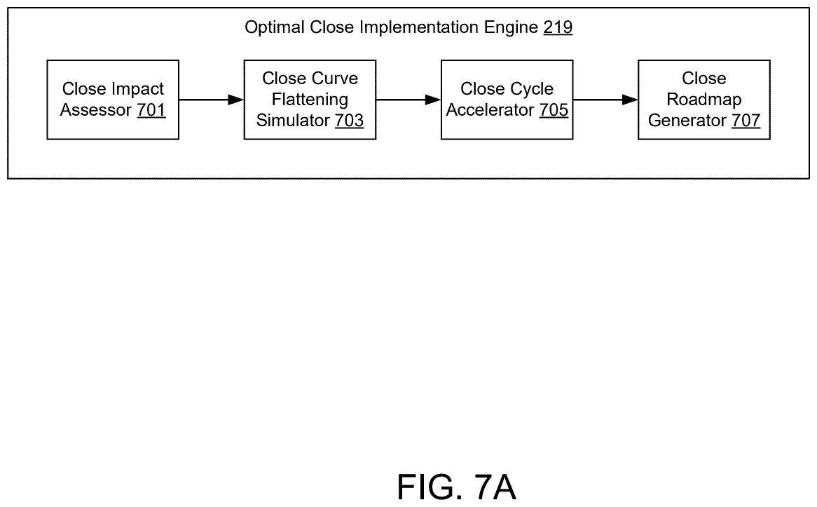

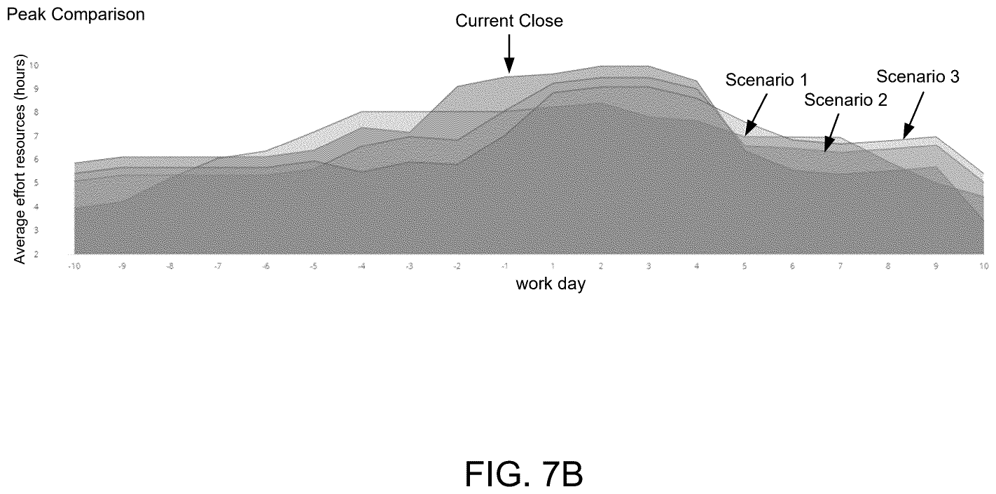

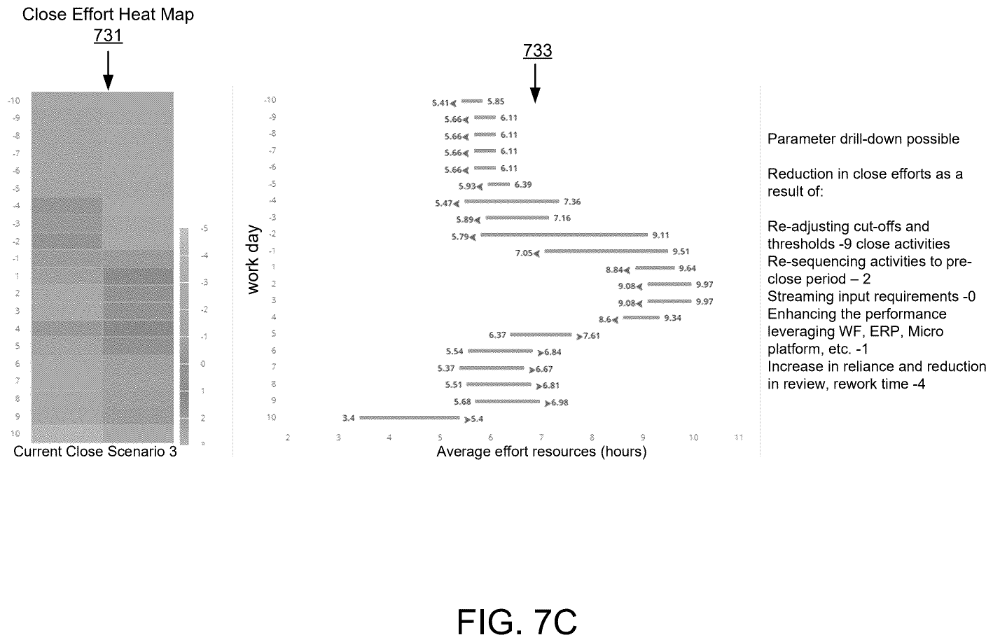

The optimum close implementation engine 219 may include various components for evaluating the simulated close scenarios. For example, the optimal close implementation engine 219 may include a close curve flattening simulator, a close cycle accelerator, and a close roadmap generator. The close curve flattening simulator may be a machine learning-powered module configured to predict the extent to which the peak load curve can be moderated in a to-be-implemented close scenario. In some embodiments, the close curve flattening simulator may be also configured to dynamically update its predictions in curve flattening based on the input changes or new learnings from the cross industry close simulator 211. The close cycle accelerator may be configured to select an optimal close scenario and/or prioritize options toward a continuous close. The close roadmap generator may be configured to generate a transformation roadmap to provide a detailed view of how the transformative initiatives will flatten the close peak. The specific functions of the optimum close implementation engine 219 are further described in FIGS. 7A-7C.

Referring now to FIG. 3A, specific functions of the cross industry close simulator 211 are further described. As shown in FIG. 3A, the cross industry close simulator 211 may be a multi-layer neural network that includes an input layer 301, a set of data layers (e.g., data layer 1 303a, data layer 2 303b, data layer 3 303c, . . . , data layer n 303n, together or individually referred to as “data layer 303”) and an output layer 305.

The input layer 301 may include a layer of nodes that are configured to receive data from different industries. For example, the nodes in the input layer 301 may include a series of nodes 311a, 311b, 311c, . . . , 311n that are configured to receive data from respective industries, such as industry 1, industry 2, industry 3, . . . , industry n. These different industries may include but are not limited to retail, life science, manufacturing and hi-tech, services, banking, insurance, CPG, and the like. The various industries may have different close related activities.

Data layer 1 303a includes a layer of neural network nodes configured to identify activities from the data received by the input layer 301. Each node may be configured to identify one or more activities from the input data from different industries. For example, the nodes in the data layer 1 may include a first node 313a for identifying activity 1 from the data from different industries, a second node 313b for identifying activity 2 from the data from different industries, a third node 313c for identifying activity 3 from the data from different industries, a fourth node 313d for identifying activity 4 from the data from different industries, . . . , and an n^{th} node 313n for identifying activity n from the data from different industries. These different activities 1-n may include certain processes, sub-processes, and tasks related to the financial close. In some embodiments, different industries may have different activities. For example, for industry 1, the identified activities may include activities 1 and 3, while for industry 3, the identified activities may include activities 3, 4, and n.

Data layer 2 303b includes a layer of neural network nodes configured to extract the frequency related features for the activities identified by the data layer 1 303a. For example, the nodes in the data layer 2 303b may include a first node 315a for identifying daily occurring activities, a second node 315b for identifying weekly occurring activities, a third node 315c for identifying monthly occurring activities, a fourth node 315d for identifying quarterly occurring activities, and an ^{th} node 315n for identifying annually occurring activities. The frequency related features for each activity may allow to determine whether or how certain activities can be further reorganized when flattening the close curve as will be described later. It should be noted that the frequency shown in FIG. 3A is merely for exemplary purposes. The numbers and types of frequency may vary, depending on the specific applications.

Data layer 3 303c includes a layer of neural network nodes 317a, 317b, and 317c that are configured to classify activities into transactional, analytical, or judgmental data. Transactional data are activities related to day-to-day operations, analytical data are designed for data analysis, while judgmental data are designed for judgment, forecast, or prediction. It should be noted that there may be more than three nodes in this layer, depending on the specific types of data in real applications.

Data layer n 303n includes a layer of neural network nodes 319a and 319b that are configured to classify activities into month-end activities and non-month end activities. Generally, month-end activities occur at month ends, while non-month end activities may occur during days other than month ends. According to some embodiments, non-month end activities may be reorganized when flatting the close curve as will be described later. It should be noted that the data layers 1-4 illustrated in FIG. 3A are provided for exemplary purposes and not for limitations. In real applications, a multi-layer neural network disclosed herein may include one or more additional layers configured to extract other features from the close related activities.

The output layer 305 may be configured to output the data processed by the data layers 1-n into different channels for further processing. In one example, the output layer 305 may output the insights related to the close cycle 321, peak simulation 323, and close matrices 325, which can be further processed by the close analytics engine 215 and close scenario generation module 217, as will be described later.

Referring now to FIG. 3B, a tree type graph 350 for a standard close calendar generated for a specific industry may be included in the continuous close accelerator 107. In the tree type graph 350, close related activities such as processes, sub-processes, and tasks are represented by nodes in the graph. As illustrated, for a standard close calendar for a specific industry, it may include a number of processes, such as general accounting 352a, inter-company (IC) 352b, clinical trial 352c, accounts payable 352d, accounts receivable 352e, fixed assets 352f, and so on.

Each process may further include a number of sub-processes. For example, for a general accounting process 352a, it may further include an accrual sub-process 352a1, a journal entry sub-process 352a2, and an account reconciliation process 352a3. For an inter-company process 352b, it may further include a transaction sub-process 352b1, an accrual sub-process 352b2, and a trading sub-process 352b3. Similarly, for the clinical trial 352c, accounts payable 352d, accounts receivable 352e, and fixed assets 352f, each may further include a set of sub-processes as illustrated in FIG. 3B.

As also illustrated in FIG. 3B, each sub-process may further include a set of tasks. For example, for the accrual sub-process 352a1, it may further include a task 352a11 to reverse the prior month accrual and a task 352a12 to calculate and post recurring entries. For the journal entry sub-process 352a2, it may further include a task 352a21 for post local generally accepted accounting principles (GAAP) adjustments, a task 352a22 for foreign currency revaluation, and a task 352a23 for reclassification journals. Similarly, for other sub-processes, each sub-process may include corresponding tasks, details of which will not be described here.

It should be noted that the tree type graph 350 is shown for exemplary purposes and not for limitations. In real applications, the shape of a tree including the numbers of nodes for processes, sub-processes, and tasks may vary.

In some embodiments, the nodes within the tree type graph 350 may have certain relationships. For example, an upper-level node (i.e., a node closer to the center of the tree in FIG. 3B) may govern one or more lower-level linked nodes. That is, the information from the lower nodes may contribute to the information of the upper nodes. Accordingly, the tree type graph 350 may also govern the information flow with the graph. When the close related data is fed into a neural network (e.g., a graph neural network or another type of neural network), dataflow within the neural network may be also governed by the tree type graph 350. In some embodiments, besides the linkages between different levels of nodes, a same level of nodes may have certain linkages or relationships. For example, for the nodes representing tasks, certain tasks may be required to be completed according to a predefined order. For example, a task corresponding to node 352d11 may be required to be completed before a task corresponding to node 352c11. An arrow between these two nodes represents such a relationship (where the arrow points to the later completed task 352c11). Similarly, another pair of nodes 352b31 and 352c21 may also have a similar relationship or other different types of relationships. Many other similar or different relationships may be also included in other node pairs, which is not limited in the present disclosure. In some embodiments, this relationship also governs the dataflow in the neural network, for example, controlling the reorganization of tasks by a neuron network based simulator during the close scenario simulation.

In some embodiments, the tree type graph 350 representing a close calendar for an industry may be further input into a neural network for further processing, such as features aggregation as shown in FIG. 3A, and/or metrics analysis as shown in FIG. 5. The tree type graph 350 may govern the dataflow during the data processing in these components. In some embodiments, the tree type graph 350 itself is a neural network, and the neural networks shown in FIG. 3A and the graph shown in 3B may be different parts of a larger neural network (e.g., parts of the continuous close accelerator 107, which itself is a large neural network).

Referring now to FIG. 4, the specific functions of the close data ingestion layer 213 are further described. According to some embodiments, the close data ingestion layer 213 may act as the input gathering engine for gathering data (e.g., current close data from a company) for a specific current close assessment. For example, for a current close assessment, the close data ingestion layer 213 may gather data for monthly close calendar 411 and full month resource efforts 431 for completing the activities in the monthly close calendar 411 for the current close. To achieve such purposes, the close data ingestion layer 213 may communicate with systems of record, systems of collaboration, and systems of engagement, such as SOR 401a and SOE 403a associated with monthly close calendar 411 and SOR 401b and SOE 403b associated with the full month resource efforts 431, for data retrieval. The data collected for the monthly close calendar 411 may include but are not limited to activity 413, frequency 415 of the activity, resource 417a for completing the activity, activity type 419a for the activity, and weekday efforts 421a for the activity. The data gathered for the full month resource efforts 431 may include but are not limited to resource 417b, activity type 419b, and weekly efforts 421b. It should be noted that the resource 417a and 417b, activity types 419a and 419b, and the weekly efforts 421a and 421b may be the same set of data for different purposes or may be different data.

In some embodiments, if there is no data readily available from the systems of record, systems of collaboration, and systems of engagement, the required data may be further input through certain input fields 405. In some embodiments, even the data retrieved from the systems of record, systems of collaboration, and systems of engagement may be further modified through the input fields 405.

In some embodiments, the close data ingestion layer 213 may act in tandem with the cross industry close simulator 211 to flag deficiencies in data including missing data based on its machine learning models (e.g., based on the nodes included in the tree type graph 350 or in another neuron network). For example, once data is retrieved or received by the close data ingestion layer 213, the data may be input into the cross industry close simulator 211, which may further check whether there is any data missing based on the nodes included in the tree type graph 350 representing the close calendar. For example, if the activity for one task node is not found, such data may be flagged, which reminds an administrator to further collect or input the missing information if necessary. In some embodiments, if no data is missing, the data gathered by the close data ingestion layer 213 may be further processed by the cross industry close simulator 211 and/or other components such as the close analytics engine 215 included in the continuous close accelerator 107.

Referring now to FIG. 5A, the functions of the close analytics engine 215 are further described. According to some embodiments, the close analytics engine 215 may include a scaling unit 501, an imputation unit 503, an outlier normalization unit 505, and a number of performance metrics determination units such as a peak calculator 507, a metrics aggregator 509, an anomaly detector 511, and a critical path modulator 513. In some embodiments, the close analytics engine 215 is a part of a neural network or itself is a neural network or machine learning model for data processing and data analysis.

In some embodiments, AI and other machine learning algorithms can be very sensitive to the scale of the features extracted from an activity associated with a node in the tree type graph. Accordingly, in some embodiments, the data obtained by the close data ingestion layer 213 may be further scaled by the scaling unit 501. According to one embodiment, the scaling may include a process of min-max scaling, where all numerical features are scaled in the range of 0 to 1. For example, weekday effort of 4 hours may be scaled to 0.5 by the scaling unit 501. In another example, the scaling may include a process of standardization, where the features are scaled so that they are transformed into a distribution with a mean of 0 and variance of 1.

The imputation unit 503 may be configured to deal with missing values. While deleting missing values is a possible approach to tackle the problem, it can lead to significant degrading of the dataset as it decreases the volume of available data. The imputation unit 503 disclosed herein may fill in the missing values, categorical or numeric. Various techniques may be used by the imputation unit 503 during the process. In one example, the imputation unit 503 may create feature clusters and then use the mean of the cluster to impute the missing values.

The outlier normalization unit 505 may be configured to handle outliers for the data received by the close data ingestion layer 213. According to some embodiments, outliers can bias AI and other machine learning models if not handled appropriately. Numerous approaches may be employed by the outlier normalization unit 505 to handle the problem, which may include but not limited to removing the outlier records, replacing outliers (e.g., handling outliers as missing data and following the relevant impute methods described above), or capping features (e.g., by establishing acceptable feature maximums and minimums and replacing outliers with these values).

In some embodiments, after data pre-processing by the scaling unit 501, imputation unit 503, and outlier normalization unit 505, the data may be further processed to generate the performance metrics using the matrices generation tools such as the peak calculator 507 and metrics aggregator 509, combined with the anomaly detector 511 and critical path modulator 513.

The peak calculator 507 may be configured to generate a peak view for the current month end close, for example, by generating a plot based on the average effort resources by hours on each workday (e.g., −10, 9, . . . , −1, 1, . . . , 10). In some embodiments, the peak calculator 507 may also generate a peak view for an augmented close, as will be described more in detail in FIG. 5B.

The metrics aggregator 509 may aggregate the gathered data to identify insights from the data. For example, the metrics aggregator 509 may aggregate close activity related data to generate peak score, utilization index, effort parity, health indictor, activity type, time-to-close (TTC):time-to-report (TTR), as further described in detail in FIG. 5B. In some embodiments, the metric aggregator 509 may be further configured to define how the data queried by a metric is calculated. For example, the metric workday effort defaults to showing the average of the time in hours it took to deal with close related activities on each workday, but one can change the aggregator to show the median time, the minimum time, the maximum time, and so on.

FIG. 5B illustrates an example current state metrics that display the output charts for peak view, activity type, health indicator, peak score, utilization index, effort parity, TTC:TTR for an assessment of the current month end close data for a company. A peak view may be generated based on the average efforts per resource (hours) in all workdays from −10 to +10 for the current month end close, where each workday of the current month end close may be sourced from the workday start, workday end, effort data fields of the client month end close calendar. An example peak view 521 for the current month end close is illustrated in FIG. 5B. As can be seen in the figure, the workday efforts peak at days −2, −1, 1, 2, 3, and 4. In some embodiments, a peak view 523 for an augmented close may be also generated by the disclosed peak calculator 507. For example, the peak calculator 507 may calculate the peak view 523 for an augmented close by using the formula: average hours per resource per day*week augmented effort/100. The week augmented effort may represent the desired week augmented effort for each week 1, week 2, week 3, and week 4 of the month. In one example, the week 1 augmented effort is 105%, the week 2 augmented effort is 90%, the week 3 augmented effort is 90%, and week 4 augmented effort is 95%.

With respect to the activity type for the as-is-state (e.g., for the current month-end close) 525, current close efforts percentage for all activity types compared to merely transactional, analytical, and judgmental activities in each stack are calculated. In the example embodiment shown in FIG. 5B, the transactional, judgmental, and analytical activities are 70%, 10%, and 20% respectively. In some embodiments, for the augmented close 527, the corresponding values (e.g., 30%, 30%, and 40%) may be input by the user as desired. In general, in an augmented close, it is desirable to have fewer transactional activities, and more analytical and/or judgmental activities.

With respect to health indicator 529, it may be values chosen by the user or set as default. With respect to peak score 531, it may be calculated by: (maximum peak hour day) divided by (average hours per day) in percentage in the current month end close. With respect to utilization index 533, it may display the number of days when working hours are less than, equal to, or greater than average hours per day for the current month end close. With respect to the effort parity 535, it may be calculated by: (efforts in week 1 and week 4) divided by (efforts in week 2 and week 3). In some embodiments, the effort parity may be also calculated based on a ratio between close days (e.g., days used for close in a close cycle such as a month/quarter) and non-close days (e.g., days not used for close in a close cycle such as a month/quarter) in the current month end close. With respect to TTC:TTR 537, it may indicate a gap (e.g., the number of days) between time-to-close and time-to-report. In some embodiments, even the book is closed, there are certain activities that need to be done in the accounting team or another different team, since only certain numbers may get reported to the market. Typically, the gap by default is 3 days, but it can be 5 days to 10 days or 15 days, or even longer.

Referring back to FIG. 5A, in some embodiments, the close analytical engine 215 may further include an anomaly detector 511 that detects anomalies in the aggregated metrics (e.g., an anomaly in peak view). The anomaly detector 511 may detect anomalies in one variable using a univariate anomaly detector, or detect anomalies in multiple variables with a multivariate anomaly detector. For example, an univariate anomaly detector may monitor and detect abnormalities in time series data (e.g., workday efforts for peak load generation). In some embodiments, the anomaly detector 511 may treat the detected anomalies using the same principles used by the outlier normalization unit 505 in dealing with the outliers.

Continuously referring to FIG. 5A, the critical path modulator 513 may be configured to perform critical path analysis according to some embodiments. For example, the critical path modulator 513 may be configured to identify workday ranges for each process/sub-process (e.g., from workday −10 to workday 3 for one process/sub-process and from workday −1 to workday 10 for another process/sub-process). In some embodiments, there are dependent activities among the processes/sub-processes. For example, some activities cannot be performed until certain other activities are completed. Accordingly, in some embodiments, the critical path analysis may identify when an activity starts and when the activity ends (i.e., the workday range for the activity), and what is the slack area associated with the activity. A slack area means if a user moves the activity within the area, it does not impact the overall cycle time. Accordingly, in a user interface configured for root cause analysis, if the workday bar for a process/sub-process is moved within a slack area (i.e., a workday range that does not affect the overall cycle time), no alert will appear and the workday bar will be moved. If the user moves the workday bar outside the slack area, a confirmation alert may appear stating “dependent task's start & end day will be updated with this change.”

In some embodiments, other different analyses not described above may be also implemented by the close analytics engine 215, e.g., certain close related data analysis by sub-process, by weekday, by source type, and so on. These analyses may include but are not limited to peak analysis and root cause analysis and so on. For peak analysis, a user can choose to check effort distribution based on resource band, and check the peak analysis by activity type, and so on. For root cause analysis, a user can choose to check the task of the maximum effort in each workday for all processes and resources for weekday range (e.g., month end). In one example, a root cause analysis may indicate that workday −3 is underutilized and more activity can be re-sequenced to be completed on this workday. In another example, a root cause analysis may indicate that allocation journal takes the bulk of the day and can be automated to approximately 50%. In some embodiments, based on the peak analysis, root cause analysis, and other different analyses, one or more tasks may be found to be a challenge (or problematic) during a journey towards a continuous close.

In the above various descriptions related to different components, the gathered data for a current month end close for an organization are processed and analyzed. In the next, different components or modules related to close scenario generation and optimal close implementation toward a continuous close are further described. Briefly, through the data processing and analysis by the above components, the continuous close accelerator 107 may identify the possible challenges or problems (i.e., possible causes preventing the current month end close from becoming a continuous close). The continuous close accelerator 107 may be further provided with certain solutions for each challenge. For example, for a task “review and clear GR/IR Open items,” it may cause problems for a continuous close. A potential solution for this task may include “automating the clearing process by using SAP invoice and goods receipt reconciliation.” In some embodiments, the continuous close accelerator 107 may include a machine learning neural network that is trained to learn various solutions for each challenge based on the training data, based on user inputs from the user(s) with expertise in the financial close in different industries, or based on other possible information sources.

In some embodiments, there may be three defined levels of potential solutions, including acceleration, efficiency, and reliability. For acceleration, there are certain subjects that can be manipulated, such as cut-offs (can be selected from define/adjust/adhere/none), thresholds (can be selected from build/re-define/dynamic/none), re-sequence (can be selected from move outside close/prepone within close/none), and inputs (can be selected from on-demand/first time-right/both/none). In one example, by re-sequencing, certain tasks may be moved outside the month end close. With respect to efficiency, it may be achieved through certain automation (which can be selected from robotic process automation/machine learning/AI/none), enhancement tools (which can be selected from cloud ERP/ERP functionality/micro platforms/workflow/blockchain/process mining (digital twin)/none), and standardization (can be selected from process/build rules/calendar days/all/none). With respect to reliability, it may be improved through certain “govern” option (can be selected from dynamic/proactive/none) and “pre-empt” option (can be selected from pre-close/mid-close/none).

It should be noted in the above various solutions, not every solution may be checked or used in close scenario simulation. Instead, one or more typical solutions may be selected instead. In some embodiments, a neural network included in the continuous close accelerator 107 may select the typical solution(s) through a training or self-learning process. For example, through the training or self-learning process, the neural network may realize that only certain solutions may contribute to efforts towards a continuous close and thus use these solutions to generate simulated close scenarios. In some embodiments, the selected solutions may get automatically mapped to the close calendar (e.g., to a neural network with nodes representing tasks in the close calendar) in generating simulated close scenarios.

Referring now to FIG. 6A, specific functions of the close scenario generation module 217 are further described. As illustrated in the figure, the close scenario generation module 217 may include a close scenario modeling engine 601 configured to generate a series of close scenario generation models 603a, 603b, . . . , 603n (together or individually referred to as close scenario generation model 603). Each model 603 may include one or more solutions for addressing the challenges (or other tasks) identified from the current month end close. According to some embodiments, solutions for general tasks that are not challenging may be also determined and/or selected. The combined solutions in each model 603 may lead to different outcomes with respect to a continuous close. A specific example of close scenario generation for generating multiple scenarios is further illustrated in FIG. 6B.

As illustrated, an example close process may include a plurality of elements 1, 2, 3, . . . , n, each of which may represent a specific challenge (or a general task) that needs to be addressed for a close cycle. For each specific challenge, there may be different solutions. These different solutions may be linked with various drivers/dimensions to make a simulated model comprehensive. In the illustrated embodiment in FIG. 6B, each challenge or task may be referred to as an element. As shown in the figure, there may be n elements for a close, where n can be any possible number. For element 1, there may be three different solutions E1.1, E1.2, and E1.3 to address the challenge or task represented by the element 1; for element 2, there may be two different solutions E2.1 and E2.2; for element 3, there may be three different solutions E3.1, E3.2, and E3.3; and for element n, there may be three different solutions EN.1, EN.2, and EN.3.

In some embodiments, when generating a simulated close scenario, these various solutions for each element may be further combined (e.g., by automatically mapping to a close calendar). Accordingly, different combinations may generate different simulated close scenarios. For example, for a generated close scenario generation model 1, it may be a combination of options E1.2, E2.2. E3.3, . . . , EN.3; for a close scenario generation model 2, it may be a combination of options E1.2, E2.1, E3.1, . . . , EN.2; and for a close scenario generation model n, it may be a combination of options E1.3, E2.1, E3.2, . . . , EN.1, as illustrated in FIG. 6B.

In some embodiments, each of the generated models 1-n may be further subjected to impact analysis, to determine of impact of driver change on the outcome and/or performance metrics. For example, as illustrated in FIG. 6B, each generated model 1/2/3/n may be subjected to analysis by a close impact assessor, close curve flattening simulator, close cycle accelerator, and close roadmap generator, as further described in detail in FIG. 7A.

In some embodiments, an optimal model may be selected from the simulated models based on the impact analysis, which may lead to a financial close closer to a continuous close. In some embodiments, an optimal model may be selected by further taking into consideration a client's demands. For example, a client may determine to only process policy changes but not do any automation, or the client may only want to do automation without any other change. The continuous close accelerator 107 disclosed herein thus helps not only provide the best possible solution but also provide an organization with the flexibility to choose at its own pace and gauge the resultant impact of every change on its close process.

Referring now to FIG. 7A, specific functions of the optimal close implementation engine 219 are further described. As illustrated in the figure, the optimal close implementation engine 219 may include a close impact assessor 701, a close curve flattening simulator 703, a close cycle accelerator 705, and a close roadmap generator 707.

The close impact assessor 701 may be configured to assess the close impact for a close scenario generated based on the solutions for addressing the challenges in the current month end close as described above. The assessment performed by the close impact assessor 701 may be similar to the assessment of the current month end close cycles. For example, certain metrics may be generated for the simulated close scenario by taking into the information associated with the solutions (which may be learned from the historical data or from prediction).

The close curve flattening simulator 703 may generate a close curve for each simulated close scenario, which may be generated similarly as the process of generating the close curve for the current month end close. FIG. 7B illustrates a comparison of generated close curves for three different close scenarios with the current month end close. As can be seen from the figure, the simulated close scenario 1 has flattened the curve better than the simulated close scenario 2 and scenario 3, while the scenario 2 and scenario 3 can also flatten the close curve of the current month end close to some extent.

The close cycle accelerator 705 may be figured to determine the current close cycle time and how it is improved for the simulated close scenarios when compared to the current month end close.

The close roadmap generator 707 may be configured to generate a roadmap for each simulated close scenario, according to some embodiments. The generated roadmap may provide a view of how each transformation initiative (e.g., each selected solution for a challenging task) will reduce the close and peak efforts to make it truly continuous.

FIG. 7C illustrates an example roadmap generated for a close scenario (e.g., close scenario 3 shown in FIG. 7B). In the left part of FIG. 7C, a close effort heat map 731 is illustrated, which displays the delta effect (i.e., the difference between the current close and the simulated close scenario 3) calculated based on (average effort per day—daily average hours per resource of assessment). In the center part of FIG. 7C, a line chart 733 displays the average efforts per day per resource for scenario 3 and the current close. Each arrow is shown between scenario 3 and the current close and the arrow points to scenario 3. The right part of FIG. 7C shows parameter drill-down, which explains possible solutions that lead to a reduction in close effort. As can be seen in FIG. 7C, the possible reasons for the improved performance for the close scenario 3 include re-adjusting cut-offs and thresholds (−9) close activities, re-sequencing activities to pre-close period (−2), streaming input requirements (−0), enhancing the performance leveraging workflow (WF), ERP, Micro platform, etc. (−1), and increase in reliance and reduction in review, rework time (−4). Here, the values in the parentheses indicate the delta effect.

In some embodiments, based on the above various evaluations, the optimal close implementation engine 219 may further prioritize the solutions or transformation initiatives to be taken when implementing a simulated close scenario. This then normalizes the time taken to perform activities every month/quarter end.

### Example Method

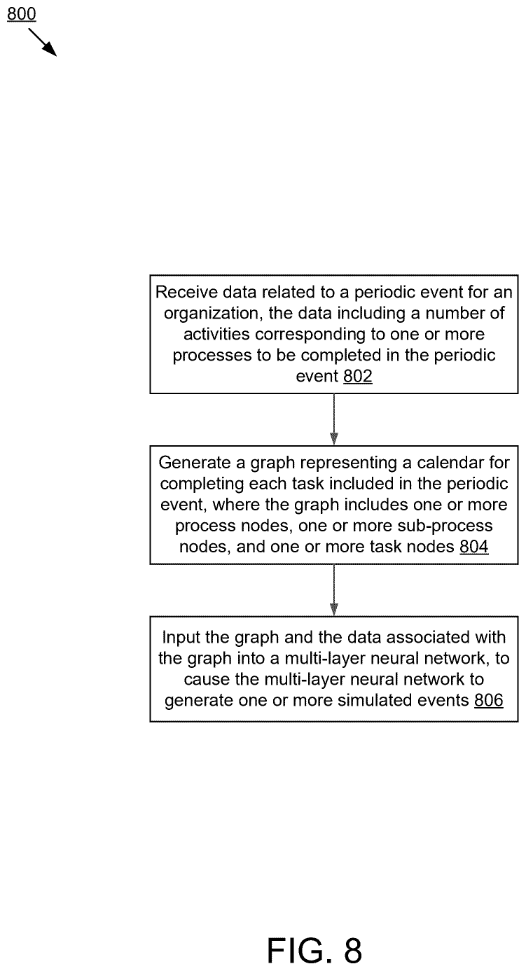

Referring now to FIG. 8, an example method 800 for generating simulated close scenarios is further described.

At step 802, data related to a periodic event for an organization is received, where the data include a number of activities corresponding to one or more processes to be completed (or completed, since these processes may be repetitive processes) in the periodic event.

In some embodiments, the periodic event is a weekly, biweekly, monthly, quarterly, or annual event. In one example, the periodic event is a current month end close event for an organization (e.g., a company from a specific industry).

In some embodiments, each process includes one or more sub-process and each sub-process includes one or more tasks to be completed in the periodic event. For example, for the month end close for a company, it may include a number of processes/sub-processes/tasks that need to be completed.

In some embodiments, the received data related to the periodic event includes a large number of activities for completing the tasks for the periodic event, where the tasks may or may not be tasks dependent on each other. For example, the data may include activities that have been completed for the current month end close. These activities may have different activity types (e.g., transactional, analytical, and judgmental), timeline (start workday, and end workday), resources used for completing the task, frequency, efforts for completing the task, and so on. These data may be used to generate a current close calendar for the industry.

At step 804, a graph representing a calendar for completing each task included in the peri the periodic event is generated. Here, the graph includes one or more process nodes representing the one or more processes, one or more sub-process nodes representing the one or more sub-processes included in each process, and one or more task nodes representing the one or more tasks included in each sub-process.

In some embodiments, the graph is a tree type graph that organizes the nodes in a tree format, as shown in FIG. 3B. The tree type graph may have a first type of linkage indicating a first relationship between each process and a sub-process included in each process, and a second type of linkage indicating a second relationship between each sub-process and a task included in each sub-process. In some embodiments, the tree type graph further includes one or more linkages each indicating a sequential relationship between a pair of tasks. For example, the tree type graph further includes one or more linkages, each with a directed arrow to indicate a sequential relationship. The sequential relationship between the pair of tasks indicates that one task is to be completed before the other task included in the pair of tasks. In some embodiments, one task may have such a relationship with more than one task, and thus there may be multiple arrows associated with the node. In some embodiments, a task may not have such a relationship, which means that it may freely move to a new timeline or it can be completed at a different time than the current month end close without affecting other tasks.

At step 806, the graph and the data associated with the graph are input into a multi-layer neural network, to cause the multi-layer neural network to generate one or more simulated events.

In some embodiments, the multi-layer neural network is a graph neural network that can take a graph and associated data as input. In some embodiments, the graph described above governs dataflow through one or more layers included in the neural network.

In some embodiments, when the periodic event is a month end close, the simulated events may be the simulated close scenarios as described earlier. In some embodiments, each of the one or more simulated events includes at least one task to be completed according to an alternative procedure that is different from an existing procedure for completing the at least one task. For example, when the data associated with the graph is input into the multi-layer neural network, the multi-layer neural network may perform a peak analysis, a root cause analysis, or other types of analyses, and thus one or more tasks are found to be challenges or problematic when the multi-layer neural network tries to transform the current month end close to a continuous close. The multi-layer neural network may then determine solutions to each challenge or problematic task, and select one or more solutions that are considered most proper in view of the client's desire, current technology, budget, and so on. According to some embodiments, solutions for general tasks that are not challenging may be also determined and/or selected. The selected solutions, when mapped back to the current month end close, then cause one or more close scenarios to be generated. These close scenarios may be then considered simulated close scenarios, or simulated events for the periodic event described earlier.

In some embodiments, one or more simulated events flatten the periodic event by reducing resources placed during the predefined time range when completing the one or more processes. As described earlier, the multi-layer neural network is configured for continuous close, and thus when the one or more solutions are selected for addressing the problematic tasks, the solutions are selected to generally flatten the close curves, accelerate the close, and/or improve the efficiency and/or reliability of the close. All of these different solutions (also referred to as basket choices as described earlier) generally cause fewer resources to be placed within a predefined time range (e.g., a close cycle, which can be a few month end workdays devoted to completing some or all tasks required in the financial close for the company).

In some embodiments, the alternative procedure causes the at least one task to be completed according to a different timeline. In some embodiments, the alternative procedure causes the at least one task to be completed outside the predefined time range. For example, a task can be moved out of the close cycle to be completed within the non-month end workdays. This then flattens the close curve for the current month end close. In some embodiments, the alternative procedure causes the at least one task to be completed through a process automation with increased efficiency, the alternative procedure causes the at least one task to be completed through a re-sequence of tasks to be completed when completing the one or more processes. All of these solutions then cause a problematic task to be completed following a different procedure, which can be a different timeline (e.g., moving to a different schedule) or can be a different process (e.g., with improved automation). This different procedure causes fewer sources to be placed within the predefined time range (e.g., within the close cycle).

In some embodiments, the multi-layer neural network is trained by using historical data related to the periodic event from one or more organizations. The one or more organizations may be from different industrial fields. In addition, the historical data may include various possible procedures for completing a task included in the periodic event.

In some embodiments, a training module is configured to train the multi-layer neural network. The training module may employ a machine learning-implemented method to train the multi-layer neural network, such as any one of a linear regression algorithm, logistic regression algorithm, decision tree algorithm, support vector machine classification, Naïve Bayes classification, K-Nearest Neighbor classification, random forest algorithm, deep learning algorithm, gradient boosting algorithm, and dimensionality reduction techniques such as manifold learning, principal component analysis, factor analysis, autoencoder regularization, and independent component analysis, or combinations thereof. In some embodiments, the training module employs supervised learning algorithms, unsupervised learning algorithms, semi-supervised learning algorithms (e.g., partial supervision), transfer learning, multi-task learning, or any combination thereof to train the multi-layer neural network.

In some embodiments, the training module trains the multi-layer neural network using various month end close training samples. In some embodiments, the various month end close training samples include training samples from different industries. In some embodiments, the various month end close training samples include some samples that can be prepared based on the predictions rather than based on the actual close related activities. For example, some activities related to a future time (e.g., a task is moved to a date after month-end close) may be predicted by using some prediction models. These predicted samples may be also used in training the multi-layer neural network, according to some embodiments. In some embodiments, the various month end close training samples may be purposely selected based on the expertise on financial close from various industries.

### Implementing Device

In some embodiments, the various continuous close acceleration application systems disclosed herein, may be implemented on a computing system with access to a hard disc or remote storage, as further described in detail below.

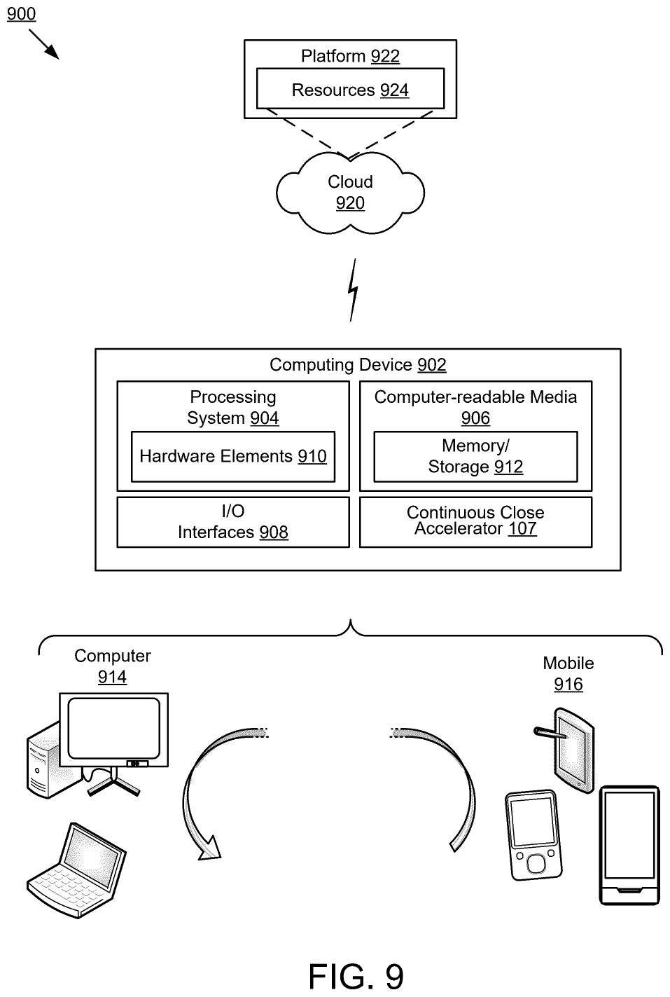

FIG. 9 illustrates an example system 900 that, generally, includes an example computing device 902 that is representative of one or more computing systems and/or devices that may implement the various techniques described herein. The computing device 902 may be, for example, a user device 103, a cloud services unit 117, or a continuous close acceleration server 101 as shown in FIG. 1, an on-chip system embedded in a device (e.g., IoT), and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of the functionality to perform one or more operations using hardware. Accordingly, the processing system 904 is illustrated as including hardware element 910 that may be configured as processors, functional blocks, and so forth. This may include implementation in hardware as an application-specific integrated circuit (ASIC) or other logic devices formed using one or more semiconductors. The hardware elements 910 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically executable instructions.

The computer-readable media 906 is illustrated as including memory/storage 912. The memory/storage 912 represents memory/storage capacity associated with one or more computer-readable media. The memory/storage 912 may include volatile media (such as random-access memory (RAM)) and/or nonvolatile media (such as read-only memory (ROM), Flash memory, optical disks, magnetic disks, and so forth). The memory/storage 912 may include fixed media (e.g., RAM, ROM, a fixed hard drive, and so on) as well as removable media, e.g., Flash memory, a removable hard drive, an optical disc, and so forth. The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 910 and computer-readable media 906 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of an engine that is executable by the computing device 902 as software may be achieved at least partially in hardware, e.g., through the use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for providing one or more device-specific AI engines, which can be further personalized. This improves the performance of an AI engine not only due to its compatibility with specific device constraints but also due to its personalized output.

In the example system 900, multiple devices are interconnected through a central computing device. The central computing device may be local to multiple devices or may be located remotely from the multiple devices. In one embodiment, the central computing device may be a cloud of one or more server computers that are connected to multiple devices through a network, the internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 902 may assume a variety of different configurations, such as for computer 914 and mobile 916 uses, and for many enterprise use, IoT user, and many other uses not illustrated in FIG. 9. Each of these configurations includes devices that may have generally different constructs and capabilities, and thus the computing device 902 may be configured according to one or more of the different device classes. For instance, the computing device 902 may be implemented as the computer 914 family of a device that includes a personal computer, desktop computer, multi-screen computer, laptop computer, netbook, and so on. The computing device 902 may also be implemented as the mobile 916 family of devices that include mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 902 and are not limited to the specific examples of the techniques described herein. This is illustrated through the inclusion of a continuous close accelerator 107 on the computing device 902, where the continuous close accelerator 107 may include different units or modules as illustrated in FIGS. 1-7C. The functionality represented by the continuous close accelerator 107 and other modules/applications may also be implemented all or in part through the use of a distributed system, such as over a “cloud” 920 via a platform 922 as described below.

The cloud 920 includes and/or is representative of platform 922 for resources 924. The platform 922 abstracts the underlying functionality of hardware (e.g., servers) and software resources of the cloud 920. Resources 924 may include applications and/or data that can be utilized while computer processing is executed on servers that are remote from the computing device 902. Resources 924 can also include services provided over the internet and/or through a subscriber network, such as a cellular or Wi-Fi network.

The platform 922 may abstract resources and functions to connect the computing device 902 with other computing devices 914 or 916. The platform 922 may also serve to abstract the scaling of resources to provide a corresponding level of scale to encountered demand for the resources 924 that are implemented via platform 922. Accordingly, in an interconnected device implementation, the implementation functionality described herein may be distributed throughout system 900. For example, the functionality may be implemented in part on the computing device 902 as well as via the platform 922 that abstracts the functionality of the cloud 920.

### Additional Considerations

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method, comprising:
receiving data related to a periodic event for an organization, the data including a number of activities corresponding to one or more processes to be completed in the periodic event, wherein each process includes one or more sub-process and each sub-process includes one or more tasks to be completed in the periodic event;
generating a graph representing a calendar for completing each task included in the periodic event, wherein the graph includes one or more process nodes representing the one or more processes, one or more sub-process nodes representing the one or more sub-processes included in each process, and one or more task nodes representing the one or more tasks included in each sub-process; and
inputting the graph and the data associated with the graph into a multi-layer neural network, to cause the multi-layer neural network to generate one or more simulated events, wherein the graph governs dataflow of the data through the multi-layer neural network, and wherein each of the one or more simulated events includes at least one task to be completed according to an alternative procedure that is different from an existing procedure for completing the at least one task, and wherein each of the one or more simulated events flattens the periodic event by reducing efforts to be placed during a predefined time range when completing each task included in the periodic event.

2. The computer-implemented method of claim 1, wherein the multi-layer neural network is a graph neural network.

3. The computer-implemented method of claim 1, wherein the graph is a tree type graph that includes a first type of linkage indicating a first relationship between each process and a sub-process included in each process, and a second type of linkage indicating a second relationship between each sub-process and a task included in each sub-process.

4. The computer-implemented method of claim 3, wherein the tree type graph further includes one or more linkages each indicating a sequential relationship between a pair of tasks.

5. The computer-implemented method of claim 4, wherein the sequential relationship between the pair of tasks indicates that one task is to be completed before the other task included in the pair of tasks.

6. The computer-implemented method of claim 1, wherein the multi-layer neural network is trained by using historical data related to the periodic event from one or more organizations.

7. The computer-implemented method of claim 6, wherein the one or more organizations are from different industrial fields.

8. The computer-implemented method of claim 6, wherein the historical data include various possible procedures for completing a task included in the periodic event.

9. The computer-implemented method of claim 6, wherein the multi-layer neural network is configured to identify the at least one task to be problematic when flatting the periodic event.

10. The computer-implemented method of claim 9, wherein the multi-layer neural network is configured to automatically determine one or more alternative procedures for the at least one task identified to be problematic.

11. The computer-implemented method of claim 1, wherein the alternative procedure causes the at least one task to be completed according to a different timeline.

12. The computer-implemented method of claim 11, wherein the alternative procedure causes the at least one task to be completed outside the predefined time range.

13. The computer-implemented method of claim 1, wherein the alternative procedure causes the at least one task to be completed through a process automation with increased efficiency.

14. The computer-implemented method of claim 1, wherein the alternative procedure causes the at least one task to be completed through a re-sequence of tasks to be completed when completing the one or more processes.

15. The computer-implemented method of claim 1, wherein the periodic event is one of a weekly event, biweekly event, monthly weekly, quarterly event, or annual event.

16. The computer-implemented method of claim 1, wherein the one or more tasks include a subset of tasks that are dependent on each other.

17. The computer-implemented method of claim 1, wherein the one or more tasks include a subset of tasks that are independent of each other

18. A system, comprising:
a processor; and
a memory, coupled to the processor, configured to store executable instructions that, when executed by the processor, cause the processor to perform operations comprising:
receiving data related to a periodic event for an organization, the data including a number of activities corresponding to one or more processes to be completed in the periodic event, wherein each process includes one or more sub-process and each sub-process includes one or more tasks to be completed in the periodic event;
generating a graph representing a calendar for completing each task included in the periodic event, wherein the graph includes one or more process nodes representing the one or more processes, one or more sub-process nodes representing the one or more sub-processes included in each process, and one or more task nodes representing the one or more tasks included in each sub-process; and
inputting the graph and the data associated with the graph into a multi-layer neural network, to cause the multi-layer neural network to generate one or more simulated events, wherein the graph governs dataflow of the data through the multi-layer neural network, and wherein each of the one or more simulated events includes at least one task to be completed according to an alternative procedure that is different from an existing procedure for completing the at least one task, and wherein each of the one or more simulated events flattens the periodic event by reducing efforts to be placed during a predefined time range when completing each task included in the periodic event.

19. The system of claim 18, wherein the multi-layer neural network is a graph neural network.

20. The system of claim 18, wherein the graph is a tree type graph that includes a first type of linkage indicating a first relationship between each process and a sub-process included in each process, and a second type of linkage indicating a second relationship between each sub-process and a task included in each sub-process.
